(19) United States
(12) Patent Application Publication
(10) Pub. No.: US 2003/0158894 A1
(43) Pub. Date: Aug. 21, 2003

(54) Multiterminal publishing system and corresponding method for using same

(76) Inventor: Francois Ziserman, Guichen (FR)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/297,221

(22) PCT Filed: May 16, 2001
(86) PCT No.: PCT/FR01/01500

(30) Foreign Application Priority Data
May 31, 2000 (FR) 00/07073

(51) Int. Cl. G06F 15/16

(52) U.S. Cl. 709/203

(57) ABSTRACT

The invention concerns a multiterminal publishing system, providing access to at least an application corresponding to a service for supplying to a plurality of terminals, in accordance with at least two different types of terminals, data contained in at least a data source. The invention is characterised in that the system comprises: at least a module (30, 301, 302, 303) for creating objects from raw data; a module (31) for generating response in a generic presentation format, in response to a request (51) made by a terminal concerning a given application; a presentation module (32), for transforming said reply in a generic presentation format specific to said terminal which has made the request.

The field of the invention is that of communication networks accessed by terminals of different types.

More exactly, the invention relates to a multi-terminal publishing system, enabling the same document to be published in different formats, so that it can be retrieved from different types of communication terminals.

The invention applies particularly, but not exclusively, to the publishing of information available on the world Internet network, or on any other Internet network, on terminals of different types, such as “Wireless Application Protocol” (WAP) terminals, “Personal Digital Assistant” (PDA) terminals, Minitel terminals, etc.

The invention also applies, for example, to the publishing of information contained in databases, files, or Java modules.

Publishing the same information on terminals of different types is made difficult by the diversity of computer languages and communication protocols employed in each terminal type. In this way, for example, Wireless Application Protocol (WAP) mobile telephones use the Wireless Markup Language (WML), while terminals such as personal computers employ a Hypertext Markup Language (HTML). Until now, several solutions have been proposed to the problem of publishing information on terminals of different types.

One first solution, enabling a service to be offered which is accessible to different terminal types, consists in developing as many versions of this service as there are terminal types able to access it. Implementing a solution of this kind guarantees a quality service presentation, adapted to the terminal type being used.

One drawback of this prior art technique is that it requires substantial development time.

Another drawback of this prior art technique is that maintenance operations are made difficult by the high number of service versions, which increases with the number of target terminal types.

In the event, for example, of a user wishing to access a Web site using a mobile telephone, it is necessary, according to this first solution, to employ a Wireless Application Protocol (WAP) gateway between the Internet network and the mobile network, and to develop a new version of the Web site, constructed from a Hypertext Markup Language (HTML), that is adapted to the mobile, in other words constructed in particular from a Wireless Markup Language (WML).

Another solution consists in automatically converting the content of the services. In this construct, a set of generic rules is used which, for example, enable the HTML pages of the Web sites to be converted into other formats, such as the WML format, or the “HTML Light” format. Such generic rules may for example consist in degrading the image quality, in converting the HTML tags, etc.

Implementing a solution of this kind, as proposed, for example, by HelpInHand ASA BabelServer (trademark), consists in republishing from language to language, using an adapted translator. According to this technique, the Uniform Resource Locator (URL) addresses are simply filtered by the translator.

One drawback of this prior art technique is that the conversion tools employed have no knowledge of the service being processed, and the result obtained is therefore of poor quality. In particular, these tools are not able to identify relevant data within the service for conversion.

Another drawback of this prior art technique is that it is solely adapted to the WML, and therefore to the automatic conversion of a Web site, so as to make it accessible to mobile telephones.

Yet another drawback of this technique is that it is does not allow the information contained in the Web site to be filtered, as a function of the destination terminal.

Yet another drawback of this prior art technique is that it does not allow an adapted payment system to be brought on line, in particular allowing WAP or PAD terminal users, for example, to access fee-based Internet services.

Other solutions, known as republishing by pre-set conversion, have been proposed, particularly in Oracle's “Portal To Go” servers and IBM's “WebSphere Transcoding Publisher” (trademarks).

Thus, the “WebSphere Transcoding Publisher” employs a conversion motor enabling, by means of a set of generic and specific rules, a direct conversion of raw data extracted from information sources in HTML or XML formats, into data in the XML format, accessible by a plurality of terminals of different types. Such a module acts as a proxy.

One drawback of this prior art technique is that the processor employed within such a module has no intelligence and is not therefore able to identify relevant information within the raw data for conversion.

Another drawback of this prior art technique is that the presentation of the converted data is directly linked to the presentation of the raw data before conversion, whatever type of terminal is used. In particular, in the event of a user wishing to access a Web site using a mobile telephone, employing the “WebSphere Transcoding Publisher” constrains the user to browse within the converted site in exactly the same way as in the original Web site.

Oracle's “Portal To Go” solution consists of a data extractor, composed of a plurality of extraction modules, and a conversion motor. Each extraction module is an Application Program Interface (API) which enables the extraction of raw data in the HTML, XML format, or from databases for example and its conversion into the XML format respectively. In this construct, an extractor searches for standard expressions, from a stored library, in other words it implements a pattern search, for example within a given web page, as a function of a pre-set grammar.

The converted data is then transformed, so as to be accessible to different types of destination terminals. The “Portal To Go” conversion motor includes as many conversion modules as there are destination terminal types: each of these models makes it possible to adapt the presentation of data converted to the XML format to the destination terminal type.

One drawback of this prior art technique is that it is complex to implement.

Another drawback of this prior art technique is that it requires significant development time, given the large number of languages (equal in number to the number of destination terminals), which have to be employed in the conversion motor.

Another drawback of this “Portal To Go” technique is that it offers the destination terminal a converted data presentation, which is dependent on the original raw data presentation.

Yet another drawback of this prior art technique is that the extractor employed does not allow automatic follow-up of any links between different Web pages. In particular, if, within a Web Page, an extractor of this kind identifies a Uniform Resource Locator (URL) address referring back to another Web Page, it does not request access to it in order to extract from it the data that it contains.

Yet another drawback of the “Portal-To-Go” technique is that it does not respect the tree structure of the Web Page from which the data constituting objects is extracted. Indeed, the standard expression search employed takes no account of the tree structure of the page being analysed. It is then possible to extract from the page a pattern belonging, partly, to a first branch, and, partly, to a second branch of the tree structure of the page. In this way, after extracting raw data contained in a Web page, any notion of browsing within the objects contained in the analysed page is lost.

The particular purpose of the invention is to overcome these drawbacks of the prior art.

More exactly, a purpose of the invention is to provide a multi-terminal publishing system, which allows the same document to be published in different formats, so that it may be retrieved from different types of communication terminal.

Another purpose of the invention is to implement a multi-terminal publishing system that is inexpensive, and uncomplicated to implement.

Another purpose of the invention is to implement a multi-terminal publishing system, which can adapt to any type of data source and any type of retrieval terminal.

Yet another purpose of the invention is to provide an open-ended multi-terminal publishing system, allowing easy adaptation to evolving information and document sources.

Another purpose of the invention is to implement a multi-terminal publishing system, wherein the concepts of data and data presentation are independent.

Another purpose of the invention is to implement a multi-terminal publishing system enabling the information from the data sources to be filtered as a function of the terminal, or of the terminal type, for which they are destined.

Another purpose of the invention is to provide a multi-terminal publishing system that is totally independent of the information source and of the destination terminal, in other words in which the processes employed depend neither on the type of information extracted from the data sources, nor on the terminal type for which they are destined.

Yet another purpose of the invention is to implement a multi-terminal publishing system, in which the content and the presentation of the information offered to the destination terminal are perfectly adapted to the destination terminal type.

Another purpose of the invention is to provide a multi-terminal publishing system adapted to all conversational terminals.

These purposes, as well as others which will emerge subsequently are fulfilled according to the invention, by using a multi-terminal publishing system, of the type offering access to at least one application corresponding to a service, making it possible to provide to a plurality of terminals, according to at least two different terminal types, information contained in at least one information source.

According to the invention, such a system includes:

at least one object creation module, enabling at least one function to be provided for creating objects from raw data extracted from said at least one information source and/or generated by said at least one object creation module;

a module generating a response in a generic presentation format, in response to a request formulated by a terminal and relating to a given application, said application being defined, within said response generation module, by a plurality of contexts and a concept of browsing among said contexts, each context including at least one action and/or at least one object, created by said at least one object creation module, said response resulting from browsing according to said concept of browsing within said plurality of contexts;

a presentation module, enabling said generic presentation format response to be converted into a response in a presentation format specific to the type of said terminal formulating said request.

Thus, the invention is based on a totally new and inventive approach to multi-terminal publishing, enabling a document to be made accessible to a plurality of terminals of different types. Indeed, it is based particularly on the new concept of separating information and information presentation. The invention is also based on a new concept of browsing within a set of contexts, in which are collected actions and/or objects created by the multi-terminal publishing system. A response from a system of this kind according to the invention to the request from a communication terminal is thus elaborated by a generic browsing technique, irrespective of the retrieval terminal type, which enables an object tree structure to be constructed, created wholly or in part from the data contained in Web sites, databases, files, or Java modules for example.

To advantage, said generic presentation format response is a tree of the XML or SGML type.

Indeed, the Extended Markup Language (XML), which is a language extracted from the Standard Generalised Markup Language (SGML), is a generic language particularly adapted to data publishing and exchange.

According to an advantageous characteristic of the invention, a system of this kind additionally includes an interfacing module enabling said terminal formulated request to be intercepted and analysed, in such a way as to:

identify said terminal type;

create a new request, in a generic request format, destined for said response generation module.

In this way, since the retrieval terminal type is identified, the system according to the invention is able to send back a response, the content and presentation of which are perfectly adapted to the terminal issuing the request.

According to an advantageous technique, each object includes at least one member relating to the structure of said object and at least one constructor, said at least one constructor allowing said at least one object creation module to inform the content of said at least one member.

It may for example be imagined that a “film” object is composed of three members, namely a first “film title” member, a second “film summary” member, and a third “director” member.

In an advantageous embodiment of the invention, said at least one object creation module belongs to the group including:

an object creation module, called a Webbike module, enabling at least one function to be provided for creating objects from raw data extracted from at least one data source containing at least one document expressed in a “markup” language;

an object creation module, enabling at least one function to be provided for creating objects from raw data extracted from at least one Structured Query Language (SQL) database;

an object creation module, constructed from a Java language, enabling at least one function to be provided for creating objects from raw data generated by said object creation module and/or extracted from at least one pre-set information source.

Such a system according to the invention thus makes it possible to publish, on a terminal issuing a request, data from multiple information sources, and particularly from Web sites, from databases, from XML files, and from data generated or extracted by employing a Java module. It is conceivable for an object to be entirely created from data extracted from a Web site. It is also conceivable for some members of an object to be informed from data extracted from a database, and, for example, for all the other members of the object, to be informed from data generated by a Java module.

The objects created by the object creation modules are preferentially described using a Service Interface Definition Language (SIDL), but any other language type adapted to the invention may also be used.

To advantage, said presentation module is constructed using an Extended Stylesheet Language (XSL).

According to one advantageous characteristic of the invention, within said response generation module, said at least one application is composed, in accordance with a first specific language, of a service container, describing said service, and of at least one context container, each corresponding to a said browsing stage.

To make reading easier, a first specific language of this kind will be called, throughout the rest of the description, a Multi-Device Server Page (MDSP). Each application is thus composed of a service container and of one or more context containers. The service container enables the instructions to be carried out when launching the application to be described. It also enables the declaration of entities (for example variables or procedures) which can be used throughout the considered application. The context container for its part enables the context, in other words a browsing stage within the considered application, to be described.

There is a single service container in each application. However, as disclosed in the remainder of the description, the invention employs instructions, which enable the service to be changed within a session. For each retrieval terminal user, the issuing of a request and the display of its response, in the course of a single session, may therefore be associated with a plurality of services.

To advantage, the container is composed of at least one component, allowing at least one instruction to be brought together.

To advantage, such a system according to the invention employs six component types:

“entry point” components, enabling the description of a first plurality of operations which said response generation module has to carry out when launching the operation of a service container or a context container;

“attribute” components, enabling the description of a plurality of variables which may be used in said current container;

“method” components, enabling a plurality of said at least one instruction within one procedure to be brought together;

“import” components, enabling the description of said at least one object necessary for said response generation module, so as to generate said response to said request relating to a given application;

“handler” components, enabling the description of a second plurality of operations which said response generation module has to carry out in response to an action taken by a terminal;

“content” components, enabling the description of said information supplied to a terminal within said response and/or the description of said at least one action which said terminal may take at a given said browsing stage.

In appendix 1 examples are given of components of the types disclosed above. This appendix, just like the ones that follow, clearly plays a full part in the present description.

Thus, an entry point component is characterised by its name, any parameters, and the set of instructions that the response generation module has to carry out when launching the operation of the service container or of the context container to which such an “entry point” component belongs.

An attribute component enables for its part the description of the variables which may be used in all the components of the current container. Thus, if the attribute component belongs to a service container, the variables that it declares are accessible from all the contexts of the considered application.

The set of instructions of a content component enable, when they are carried out, an XML tree to be generated containing all the information that the multi-terminal publishing system according to the invention offers the terminal issuing the considered request.

To advantage, a system of this kind according to the invention employs the four following instruction types:

“content” instructions, enabling the generation of a part of said response in a generic presentation format;

“manipulation of variables” instructions, enabling at least one variable to be declared and/or manipulated;

“browse” instructions, enabling the current context and/or the current application to be changed;

“use” instructions, able to be used by instructions and/or components.

According to a first advantageous characteristic of the invention, said “content” instructions belong to the group including:

a “content-literal” instruction, enabling a string of characters of said generic format response to be described;

a “content-object” instruction, enabling an object to be described;

a “content-list” instruction, enabling a list of objects to be described;

a “content-item” instruction, enabling one element from a list to be described;

a “content-member” instruction, enabling one member of an object to be described;

a “content-selection” instruction, enabling one item to be selected from a list;

a “content-multiple-selection” instruction, enabling at least one item to be selected from a list;

a “content-entry” instruction, enabling the description of one “entry” item through which said terminal formulating said request is able to enter a value;

a “content-action-scroll; instruction making it possible to move around within a list;

a “content-action” instruction, enabling an action to be described;

a “content-change of context-action” instruction, enabling an action to be described which allows said terminal formulating said request to change context;

a “content-previous context-action” instruction, enabling said terminal formulating said request to return to the previous context.

Thus, the “content-literal” instruction, which enables the description of a string of characters to be inserted into the XML tree constituting the response, is characterised by the character string to be inserted and the name of the node of the XML tree generated.

The “content-object” instruction enables, for its part, the description of an SIDL object which the system according to the invention offers the terminal issuing the processed request. An object of this kind may be referenced by its name in all the components of the context to which the “content” component belongs. In order for the “content” component containing this instruction to be correctly executed, the “content-object” must be initialised before calling the instruction executing the “content” component.

In appendix 2 are given some examples of “content” instructions.

According to a second advantageous characteristic of the invention, said “manipulation of variables” instructions belong to the group including:

an “object” instruction, enabling an “object” variable to be declared;

a “list” instruction, enabling a “list” variable to be declared;

a “simple” instruction, enabling a “simple” variable to be declared, distinct from said “object” type and said “list” type;

a “create” instruction, enabling an object or a list of objects to be constructed;

a “set up” instruction, enabling a value to be assigned to a variable;

a “list-move” instruction enabling a current list pointer to be moved, specifying a movement pitch;

a “list-move to” instruction, enabling a current list pointer to be moved, specifying a new position for said pointer.

Indeed, the MDSP language makes it possible to declare and to manipulate variables, which may be used in order to store information or to transmit parameters.

Thus, the “object” instruction enables an object variable to be declared. This object may be referenced by its name in all the components of the current container. Before being referenced, it must be initialised using a pre-set instruction. The “object” instruction is characterized by the name of the variable declared and by an SIDL object class.

The “simple” instruction enables for its part the declaration of a simple variable, in other words a variable able to contain a character string, an integer or a floater. It is characterised by the name of the variable and by the value possibly taken by this variable at initialisation.

The “create” instruction makes it possible to construct an object or a list of SIDL objects declared in the current context or in the current service. It is characterised by the name of the variable to be constructed, the SIDL constructor to be used and the values assigned to the parameters of the constructor.

In appendix 3 some examples are given of “manipulation of variables” instructions.

According to a third advantageous characteristic of the invention, said “browse” instructions belong to the group including:

a “change-context” instruction, enabling a new context to be instanced;

a “change-service” instruction, enabling a new service to be instanced;

a “context-previous” instruction, making it possible to return to the previous context in the current service;

a “service-previous” instruction, making it possible to return to the previous context with the last context of said service.

Indeed, at a given moment, for a given customer (in other words for a given terminal issuing a request to the multi-terminal publishing system according to the invention), there is a single current context and a single current service. The MDSP language enables this current context and this current service to be changed through “browse” instructions.

Thus, a “context-previous” instruction makes it possible to return to a previous context in the current service. The current context then becomes this context, in the state in which it was left the last time. The presentation returned to the terminal issuing the request therefore corresponds to that described by the last “content” component executed on this context.

In appendix 4 some examples are given of “browse” instructions.

According to a fourth advantageous characteristic of the invention, said “use” instructions belong to the group including:

a “call” instruction, enabling a “method” component to be called up in the current context or service;

an “if” instruction, making it possible to set up a condition over a set of instructions;

an “if not” instruction, following an “if” instruction and enabling a condition to be set over a set of instructions;

an “if not-if” instruction, following an “if” instruction and enabling at least one other condition to be set over said set of instructions;

a “run-content” instruction, enabling a presentation to be generated of said information described in a “content” component;

an “SIDL-import” instruction, enabling an object to be used in the current service to be specified;

a “parameter-list” instruction, enabling parameter declarations to be brought together;

a “parameter” instruction, enabling a parameter value to be specified;

a “do” instruction, enabling actions to be carried out when launching a context operation to be brought together in a “handler” component;

an “on” instruction, enabling conditions having to be validated in order for a “handler” component to operate to be brought together.

Indeed, there are also, within the MDSP language, different instructions, which may be used by instructions or components.

Thus, a “call” instruction makes it possible to call up a method (in other words a “method” component) declared in the current context or in the current service. It is characterised by the name of the method called up and by the values assigned to the parameters of the method.

A “run-content” instruction makes it possible to trigger the generation of the presentation of the information described by a contained component. It is characterised by the name of the content for which it is desired to generate the presentation and the name of the XSL model that it is desired to use, if it is not desired to use that of the content.

In appendix 5 some examples are given of “use” instructions.

To advantage, on reception by said at least one object creation module of a request for at least one object, said request coming from said response generation module, said at least one object creation function employs at least one extraction sub-function, making it possible to inform the content of at least one member relative to the structure of said at least one object.

To advantage, said at least one object creation function additionally includes one sub-function for comparison of said at least one object relating to said request with a list of previously at least partially created objects, so as to employ said at least one extraction sub-function only to create objects not previously created and/or to complete previously partially created objects.

Thus, if an object has already been created in response to a request, previously processed by the multi-terminal publishing system according to the invention, this object is re-used in elaborating the response to the request which is being processed, and is sent straight to the response generation module.

To advantage, within said Webbike module, each extraction sub-function is composed, in accordance with a second specific language, of at least one Webbike page including at least one Webbike node,

and said at least one Webbike page is synchronised with at least one document expressed in a “markup” language from at least one data source, said at least one document itself including at least one “markup” language node, said synchronisation enabling a Webbike node to position itself on a “markup” language node so as to extract from it raw data for the purpose of said object creation.

Throughout the remainder of the document, a second specific language of this type is termed Webbike language: the Webbike language makes it possible to create SIDL objects and to initialise the value of their attributes, from information contained in a “markup” language data source. The Webbike language enables a concrete service to be described. Consequently, a given Webbike page is able to contain the description of several associated documents expressed in a “markup” language, for example of several HTML pages whatever the address of the server supplying them.

The principle of a Webbike language of this type is to indicate to the object creation module termed Webbike module, how to search for information in HTML pages, or in XML documents, for example. In this construct, a number of Webbike nodes (also termed Webbike tags) make it possible to synchronise with the “markup” language source being considered. Synchronisation enables the Webbike module to position itself on a “markup” language node, and to extract data from it, such as the value of its attributes, for example, so as to assign it to the SIDL object members.

To advantage, within said Webbike module, on receiving a request from at least one first object, said extraction sub-function additionally makes it possible to inform the content of at least one member of at least one second object, different from said at least one first object, when raw data enabling said content to be informed is present within said document with which said at least one Webbike page is synchronised.

Thus, when the object creation module according to the invention accesses, for example, a Web Page, it creates, at least partially, all the objects likely to be created from information contained in this web page. The extraction sub-function therefore extracts all the raw data enabling the content of the object members to be informed, including objects unrelated to the request being processed.

Thus, the object creation module according to the invention optimises access to data sources, by running through and analysing once only each of the Web pages or XML documents contained in the data sources. By way of example, the object creation module accesses a given Web page in order to create a “film” object: it then also extracts the raw data contained in the page and making it possible to inform at least some of the “director” and “film festival” object members.

According to one advantageous characteristic of the invention, there are at least the three following types of Webbike nodes:

Webbike synchronisation nodes, making it possible to search for a “markup” language node or a “markup” language node “frame” in said at least one document expressed in a “markup” language, in order to position themselves on said “markup” language node or said “frame”;

Webbike structure nodes, making it possible to define at least one condition for operating said Webbike synchronisation nodes;

Webbike command nodes, making it possible to implement at least one pre-set operation after positioning on said “markup” language node or on said “frame”.

The set of Webbike nodes constitutes a Webbike instruction tree controlling an interpreter so as to be able to “browse” within the data source being analysed. Such browsing is triggered by the reception, by the Webbike module, of an object creation request.

There are, according to the invention, a number of synchronisation nodes enabling synchronisation on a “markup” language node of the page or document analysed by the object creation module. By way of example we may cite a Webbike node of the kind enabling synchronisation on the next HTML comment, or a Webbike node of the type enabling synchronisation to be conditioned on the content of a “markup” language node. This synchronisation condition may in particular consist in carrying out a search for standard expressions within the content of said “markup” language node. It should be noted that a standard expression search of this kind is also used, within a Web Page, in the “Portal-To-Go” multi-terminal publishing system, but for quite another purpose (direct search for patterns in a page, without respecting the tree structure of the page, and not synchronisation on the HTML elements of this page, for the purpose of extracting the raw data contained in each of the nodes). To advantage, there is furthermore at least one of the following Webbike node types:

Webbike nodes of the type enabling the definition of an extraction sub-function; (Webbike tag)

Webbike nodes of the type enabling the display of the object or objects used in an extraction sub-function; (implements tag)

Webbike nodes of the type enabling the definition of a Webbike page; (page tag)

Webbike nodes of the type able to be re-used with possibly a list of parameters; (method tag)

Webbike nodes of the type enabling the declaration of the parameters of a page or of a re-usable node; (param-list tag)

Webbike nodes of the type enabling another Webbike page to be called up without synchronisation on a “markup” language node; (link tag)

Webbike nodes of the type enabling a re-usable node to be called up; (call tag)

Webbike nodes of the type enabling the link to another Webbike page to be made; (action tag)

Webbike nodes of the type enabling the definition of a dynamic URL for an HTML page; (dynamic-url tag)

Webbike nodes of the type enabling a value to be assigned to a parameter; (param tag)

Webbike nodes of the type enabling a sequence of at least one Webbike node to be repeated; (multiple tag)

Webbike nodes of the type enabling at least one command to be included in a normally unauthorised location of a sequence of at least one Webbike node; (block tag)

Webbike nodes of the type enabling at least two methods of synchronisation to be defined depending on the content of a document; (switch tag)

Webbike nodes of the type enabling a sequence of at least one Webbike node to be interpreted conditionally. (if/else tag)

In appendix 6 examples are given of the syntax associated with some of the Webbike nodes described above.

To advantage, said command type Webbike nodes belong to the group including:

Webbike nodes of the type enabling the definition of a block of at least one command associated with a node (Webbike tag) of the type enabling the definition of an extraction sub-function; (command tag)

Webbike nodes of the type enabling the extraction of the textual content of a “markup” language node; (body tag)

Webbike nodes of the type enabling the extraction of at least one attribute of the current “markup” language node; (attributes tag)

Webbike nodes of the type enabling a constant value to be designated; (constant tag)

Webbike nodes of the type enabling functions to be provided for converting information extracted from a file expressed in a “markup” language. (substring—function, wordextract—function, url—check—function, Java—function)

According to an advantageous technique of the invention, said at least one command, of a block defined by a Webbike node, belongs to the following group:

object creation commands;

commands for modification of at least one object member.

There is thus, in particular, a command for the creation of a new SIDL object, a command enabling the members of an SIDL object to be updated, and a command enabling text to be added to an SIDL object member.

To advantage, there are at least the two following Webbike page types:

static Webbike pages, analysed when launching said extraction sub-function;

dynamic Webbike pages, accessible from another Webbike page via a Webbike node of a particular type, called a Webbike link.

Thus, the static pages have a fixed URL, specified in a given Webbike node, called a “page” node, and are analysed when launching the application. Generally at least one static page is needed within a service. The dynamic pages are reached by using a Webbike link. A dynamic page may define parameters enabling objects to be passed from page to page. A parameter may be a simple object, like a character string, or an SIDL object.

To advantage, there is at least one specific synchronisation Webbike node enabling a search for a pre-set “markup” language node, in order to position itself on said pre-set “markup” language node, and, additionally, a generic synchronisation Webbike node enabling a search for a non-pre-set “markup” language node which is not pre-set but specified as a parameter, in order to position itself on said non-pre-set “markup” language node.

Indeed, “markup” languages, such as XML, WML or HTML are too rich to be able to provide a Webbike synchronisation node for each existing “markup” language node. In order not to needlessly overload the Webbike language, there is, according to the invention, a generic synchronisation Webbike node, which allows synchronisation on any “markup” language node, provided the name of the element on which synchronisation is required is specified.

Preferentially, at least some of the synchronisation nodes take account of extraction conditions relating to attributes and/or to a textual content and/or to at least one son node of a found “markup” language node.

If several embedded nodes meet the criteria specified in the extraction conditions, the first node encountered is generally accepted.

Preferentially, said Webbike node implements a cookie management function.

Thus, the cookies sent by an HTTP server when retrieving an HTML page are stored in the Webbike module. They are sent back automatically by the Webbike module when it accesses pages corresponding to the cookie domain. Since some Web sites depend on the management of cookies, it is important to identify the resource causing the cookie to be sent, so as to access it from the Webbike module at the opportune moment.

In an advantageous embodiment of the invention, at least one of said first and second specific languages is constructed using an XML language.

Advantageously, said “markup” language belongs to the group including:

Extended Markup Languages (XML);

HyperText Markup Languages (HTML);

Standard Generalised Markup Languages (SGML) and derivatives;

Wireless Markup Languages (WML).

The invention also concerns a process for implementing a system according to any one of claims 1 to 26, characterised in that it includes the following stages:

a terminal issues a request relating to a given application destined for said system;

to develop a response to said request, said response generation module issues a request for at least one object to said at least one object creation module, so as to inform the plurality of contexts of said application;

said at least one object creation module creates said at least one object and sends it back to said response generation module;

said response generation module generates a response in a generic presentation format, employing said browsing according to said browsing concept within said plurality of contexts

said presentation module receives from said response generation module said generic presentation format response and converts it into a response in a presentation format specific to the type of said terminal formulating said request;

said system sends said response in a presentation format specific to said terminal.

To advantage, said process is iterative, and the response to a given request depends on said browsing concept and on at least one request and/or previous response.

Other characteristics and advantages of the invention will emerge more clearly from reading the following description of a preferential embodiment, given purely by way of example and non-restrictively, and the appended drawings, among which:

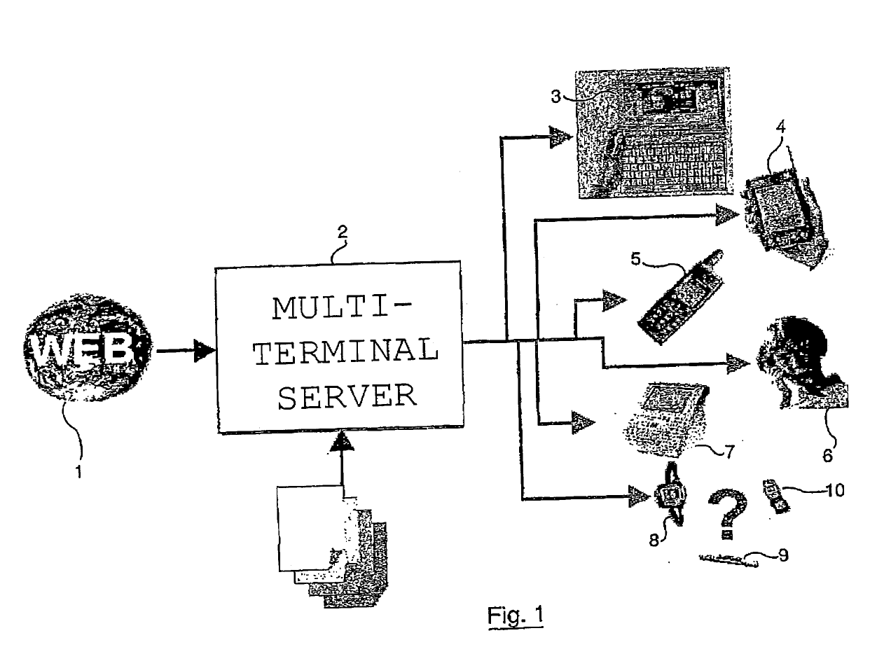

FIG. 1 shows a block diagram of the different types of terminal able to take advantage of a multi-terminal publishing system according to the invention;

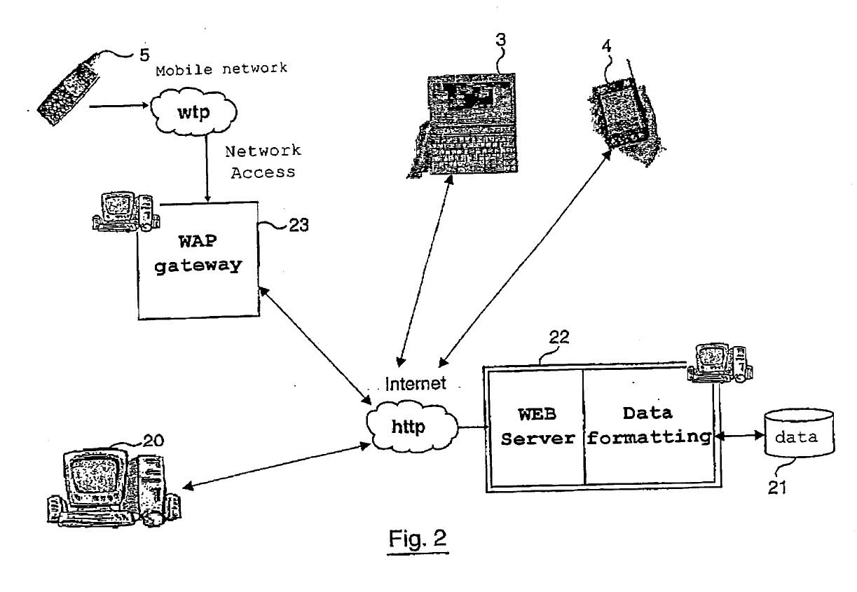

FIG. 2 shows the general architecture of a multi-terminal system publishing on the terminals shown in FIG. 1;

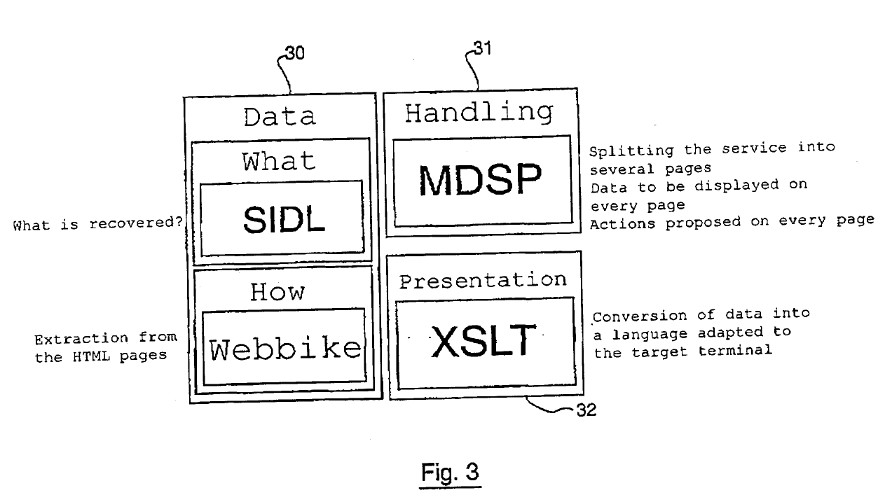

FIG. 3 shows a block diagram of the different modules employed in a multi-terminal publishing system according to the invention;

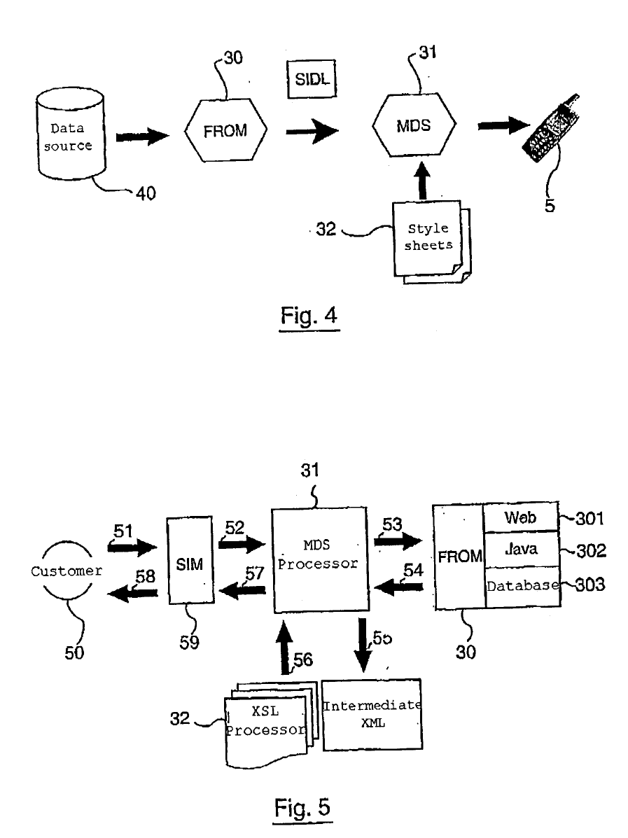

FIG. 4 describes more exactly the architecture of the multi-terminal publishing system shown in FIG. 3;

FIG. 5 shows the different stages implemented when handling a request addressed by a customer of the multi-terminal publishing system in FIG. 3.

The general principle of the invention rests on implementing a multi-terminal publishing system, based on handling a generic service, irrespective of its format in a data source and of its final presentation in the target terminal.

A block diagram is given, relative to FIG. 1, of the different types of terminal able to access a service, extracted for example from a Web site 1, from a multi-terminal publishing system 2 according to the invention.

Terminals of different types may, for example, be distinguished such as a Personal Digital Assistant (PDA) terminal 3 or 4, a Wireless Application Protocol (WAP) mobile telephone 5, a fixed telephone terminal 6, a Minitel terminal 7, or again any other type of terminal, and particularly conversational terminals 8, 9 and 10.

The general architecture of a multi-terminal publishing system is given in FIG. 2. The terminals 3, 4 and 5, already shown in FIG. 1, and a personal computer terminal 20 have access via an HTTP protocol to the data 21 extracted and broadcast on the world Internet network or on any other Internet network through the Web server 22.

Since the WAP terminal 5 does not accept the HTTP protocol, a WAP gateway 23 is employed, so as to interface between the HTTP protocol and the WTP protocol used on the mobile network.

We give now, in relation to FIG. 3, the different modules employed in a multi-terminal publishing system according to the invention, in the particular event of the data sources employed being Web sites composed of one or more HTML pages.

A multi-terminal publishing system of this kind consists in this case of 3 main modules:

an object creation module 30;

a module generating a response in a generic format, using the language known as MDSP;

a presentation module 32

The object creation module 30 employs a sub-function for extracting data contained in the HTML pages, by synchronisation on the HTML nodes. It creates objects using the Service Interface Definition Language (SIDL), then transmits them to the response generation module 31.

The generic format response generation module 31 employs a computer language based on an XML language. It retrieves the SIDL objects created by the object creation module 30.

The presentation module 32 uses style sheets, specific to each type of retrieval terminal, in order to format the data coming from the response generation module 31, in other words the intermediate XML tree supplied by the module given the reference number 31, in a format the destination terminal can read.

A more detailed description is given in relation to FIG. 4 of the architecture of the multi-terminal publishing system, the different modules of which are shown in FIG. 3.

Some data, contained in a data source 40 (for example, an XML file, a Web site, a database, etc.) is extracted by an object creation module 30, in order to fill in the members of some objects, required in constructing a response to a retrieval terminal 5. The module 30 employs a specific language, which allows the creation of Service Interface Definition Language (SIDL) objects.

The SIDL objects are then transmitted to the response generation module 31 in a generic presentation format, which elaborates a response in the form of an XML tree.

An XML tree of this kind is then processed by a presentation module, which employs a set of style sheets 32. Each style sheet is associated with a retrieval terminal type, and enables the presentation criteria specific to each terminal type to be defined. It is therefore conceivable for the presentation module to use one style sheet characteristic of WAP terminals, one style sheet characteristic of Minitel terminals, one style sheet characteristic of PDA terminals, etc.

The presentation module 32 is then able to provide, to the terminal 5 issuing a request to the multi-terminal publishing system according to the invention, a response, the content and presentation of which are adapted to the retrieval terminal type 5 (here, a WAP terminal).

The object creation 30, response generation 31, and presentation 32 modules therefore function independently, on the one hand, of the nature of the data source 40, and on the other hand of the retrieval terminal type 5.

We now give in relation to FIG. 5, the different stages implemented when the multi-terminal publishing system handles a request from a customer terminal.

In a first stage, a customer 50 having a terminal adapted to the multi-terminal publishing system according to the invention, issues a request 51 to access a set of information. For example, the customer 50 may request access to a given Web site, or to a set of information contained in a particular database. The customer 50 may further request information which the multi-terminal publishing system according to the invention has, for example, to partially extract from a Web site, partially extract from a database, and partially generate by implementing a Java module.

It is thus conceivable for the customer 50 to wish, for example, to know the list of cultural events which will take place in a given town over the coming months.

According to the embodiment shown in FIG. 5, the multi-terminal publishing system according to the invention includes, apart from the modules shown in FIGS. 3 and 4, an interfacing module 59, enabling the request 51 to be intercepted and analysed.

After analysing the request 51, the interfacing module 59 determines the terminal type used by the customer 50 to issue the request 51, in such a way that the multi-terminal publishing system according to the invention is able to transmit to the customer 50 a response, the content and presentation of which are adapted to the retrieval terminal type. The interfacing module 59 then transmits his request to the generic format response generation module 31, in a stage given the reference number 52.

In a stage given the reference number 53, the response generation module 31 issues in its turn a request to all the object creation modules 30, so as to require the creation of objects necessary for the construction of a response to the customer 50.

The set of object creation modules 30 interrogates a set of data sources, in order to extract from them the information requested by the response generation module 31. For example, a Java module 302 generates some SIDL objects, an object creation module 301, called Webbike, extracts SIDL objects from one or more Web sites by synchronisation on the HTML tags, and an object creation module 302 creates SIDL objects from the raw data contained in one or more databases.

In a stage given the reference number 54, the set of object creation modules 30 transmits to the generic format response generation module 31 the SIDL objects created in response to the request 53, as well as SIDL objects, necessary for the generation of a response to the request 51 from the customer 50, previously created by the set of object creation modules 30. For example it is conceivable for a part of the response previously transmitted to another customer 50 to be re-used to elaborate a response to the request 51; in this case, the set of object creation modules 30 transmits to the response generation module 31 the objects already previously created, for example by extraction from a Web site and/or from a database and/or from a Java module.

In this construct, on receiving a request 53, the set of object creation modules 30 implements a comparison of the objects required by the response generation module 31 with a list of previously created objects, so as to employ the object extraction or generation functions only for objects which have not been previously created.

The generic format response generation module 31 then implements browsing within the plurality of contexts relating to the service required by the customer 50 in the stage 51. Browsing of this kind within the contexts, wherein the SIDL objects provided by the object creation modules 30 are brought together, allows the generic format response generation module 31 to elaborate an XML tree, in a stage given the reference number 55.

The presentation module 32 then processes this intermediate XML tree, so as to present the response sent to the customer 50 in a format adapted to the retrieval terminal type. In this construct, the presentation module 32 uses a set of style sheets shown in FIG. 4, and bringing together the presentation characteristics specific to each retrieval terminal type.

In a stage given the reference number 56, the presentation module 32 sends the response, in a presentation format specific to the terminal type formulating the request 51, to the response generation module 31. The module 31 then returns the final response to the interfacing module 59 in a stage given the reference number 57.

The final response, in a presentation format adapted to the terminal type used by the customer 50, is then routed to the retrieval terminal, in a stage given the reference number 58.

[image]

[image]

[image]

[image]

[image]

[image]

[image]

1. A multi-terminal publishing system (2), of the type offering access to at least one application corresponding to a service, making it possible to provide to a plurality of terminals (3-10), according to at least two different terminal types, information contained in at least one information source (40),
characterised in that it includes:
at least one object creation module (30, 301-303), enabling at least one function to be provided for creating objects from raw data extracted from said at least one information source and/or generated by said at least one object creation module;
a module (31) generating a response in a generic presentation format, in response to a request (51) formulated by a terminal and relating to a given application, said application being defined, within said response generation module, by a plurality of contexts and a concept of browsing among said contexts, each context including at least one action and/or at least one object, created by said at least one object creation module, said response resulting from browsing according to said concept of browsing within said plurality of contexts;
a presentation module (32), enabling said generic presentation format response to be converted into a response in a presentation format specific to the type of said terminal formulating said request.

2. A system according to claim 1, characterised in that generic presentation format response is a tree of the XML or SGML type.

3. A system according to any one of claims 1 and 2, characterised in that it additionally includes an interfacing module (59) enabling said terminal formulated request (51) to be intercepted and analysed, in such a way as to:
identify said terminal type;
create a new request (52), in a generic request format, destined for said response generation module.

4. A system according to any one of claims 1 to 3, characterised in that each object includes at least one member relating to the structure of said object and at least one constructor, said at least one constructor allowing said at least one object creation module (30) to inform the content of said at least one member.

5. A system according to any one of claims 1 to 4, characterised in that said at least one object creation module (30) belongs to the group including:
an object creation module (301), called a Webbike module, enabling at least one function to be provided for creating objects from raw data extracted from at least one data source containing at least one document expressed in a “markup” language;
an object creation module (303), enabling at least one function to be provided for creating objects from raw data extracted from at least one SQL database;
an object creation module (302), constructed from a Java language, enabling at least one function to be provided for creating objects from raw data generated by said object creation module and/or extracted from at least one pre-set information source.

6. A system according to any one of claims 1 to 5, characterised in that said presentation module (32) is constructed using an XSL language.

7. A system according to any one of claims 1 to 6, characterised in that within said response generation module (31), said at least one application is composed, in accordance with a first specific language, of a service container, describing said service, and of at least one context container, each corresponding to a said browsing stage.

8. A system according to claim 7, characterised in that a container is composed of at least one component, allowing at least one instruction to be brought together.

9. A system according to claim 8, characterised in that it employs six component types:
“entry point” components, enabling the description of a first plurality of operations which said response generation module has to carry out when launching the operation of a service container or a context container;
“attribute” components, enabling the description of a plurality of variables which may be used in said current container;
“method” components, enabling a plurality of said at least one instruction within one procedure to be brought together;
“import” components, enabling the description of said at least one object necessary for said response generation module, so as to generate said response to said request relating to a given application;
“handler” components, enabling the description of a second plurality of operations which said response generation module has to carry out in response to an action taken by a terminal;
“content” components, enabling the description of said information supplied to a terminal within said response and/or the description of said at least one action which said terminal may take at a given said browsing stage.

10. A system according to any one of claims 8 and 9, characterised in that it employs the four following instruction types:
“content” instructions, enabling the generation of a part of said response in a generic presentation format;
“manipulation of variables” instructions, enabling at least one variable to be declared and/or manipulated;
“browse” instructions, enabling the current context and/or the current application to be changed;
“use” instructions, able to be used by instructions and/or components.

11. A system according to claim 10, characterised in that said “content” instructions belong to the group including:
a “content-literal” instruction, enabling a string of characters of said generic format response to be described;
a “content-object” instruction, enabling an object to be described;
a “content-list” instruction, enabling a list of objects to be described;
a “content-item” instruction, enabling one element from a list to be described;
a “content-member” instruction, enabling one member of an object to be described;
a “content-selection” instruction, enabling one item to be selected from a list;
a “content-multiple-selection” instruction, enabling at least one item to be selected from a list;
a “content-entry” instruction, enabling the description of one “entry” item through which said terminal formulating said request is able to enter a value;
a “content-action-scroll” instruction making it possible to move around within a list;
a “content-action” instruction, enabling an action to be described;
a “content-change of context-action” instruction, enabling an action to be described which allows said terminal formulating said request to change context;
a “content-previous context-action” instruction, enabling said terminal formulating said request to return to the previous context.

12. A system according to claim 10, characterised in that said “manipulation of variables” instructions belong to the group including:
an “object” instruction, enabling an “object” variable to be declared;
a “list” instruction, enabling a “list” variable to be declared;
a “simple” instruction, enabling a “simple” variable to be declared, distinct from said “object” type and said “list” type;
a “create” instruction, enabling an object or a list of objects to be constructed;
a “set up” instruction, enabling a value to be assigned to a variable;
a “list-move” instruction enabling a current list pointer to be moved, specifying a movement pitch;
a “list-move to” instruction, enabling a current list pointer to be moved, specifying a new position for said pointer.

13. A system according to any one of claims 10 to 12, characterised in that said “browse” instructions belong to the group including:
a “change-context” instruction, enabling a new context to be instanced;
a “change-service” instruction, enabling a new service to be instanced;
a “context-previous” instruction, making it possible to return to the previous context in the current service;
a “service-previous” instruction, making it possible to return to the previous context with the last context of said service.

14. A system according to any one of claims 10 to 13, characterised in that said “use” instructions belong to the group including:
a “call” instruction, enabling a “method” component to be called up in the current context or service;
an “if” instruction, making it possible to set up a condition over a set of instructions;
an “if not” instruction, following an “if” instruction and enabling a condition to be set over a set of instructions;
an “if not-if” instruction, following an “if” instruction and enabling at least one other condition to be set over said set of instructions;
a “run-content” instruction, enabling a presentation to be generated of said information described in a “content” component;
an “sidl-import” instruction, enabling an object to be used in the current service to be specified;
a “parameter-list” instruction, enabling parameter declarations to be brought together;
a “parameter” instruction, enabling a parameter value to be specified;
a “do” instruction, enabling actions to be carried out when launching a context operation to be brought together in a “handler” component;
an “on” instruction, enabling conditions having to be validated in order for a “handler” component to operate to be brought together.

15. A system according to any one of claims 1 to 14, characterised in that on reception by said at least one object creation module (30) of a request for at least one object, said request coming from said response generation module (31), said at least one object creation function employs at least one extraction sub-function, making it possible to fill in the content of at least one member relating to the structure of said at least one object.

16. A system according to claim 15, characterised in that said at least one object creation function additionally includes one sub-function for comparison of said at least one object relating to said request with a list of previously at least partially created objects, so as to employ said at least one extraction sub-function only to create objects not previously created and/or to complete previously partially created objects.

17. A system according to any one of claims 15 and 16, characterised in that within said Webbike module (301), each extraction sub-function is composed, in accordance with a second specific language, of at least one Webbike page including at least one Webbike node, and in that said at least one Webbike page is synchronised with at least one document expressed in a “markup” language from at least one data source, said at least one document itself including at least one “markup” language node, said synchronisation enabling a Webbike node to position itself on a “markup” language node so as to extract from it raw data for the purpose of said object creation.

18. A system according to claims 4 and 17, characterised in that within said Webbike module, on receiving a request for at least one first object, said extraction sub-function additionally makes it possible to fill in the content of at least one member of at least one second object, different from said at least one first object, when raw data enabling said content to be filled in is present within said document with which said at least one Webbike page is synchronised.

19. A system according to any one of claims 17 and 18, characterised in that there are at least the three following types of Webbike nodes:
Webbike synchronisation nodes, making it possible to search for a “markup” language node or a “markup” language node “frame” in said at least one document expressed in a “markup” language, in order to position themselves on said “markup” language node or said “frame”;
Webbike structure nodes, making it possible to define at least one condition for operating said Webbike synchronisation nodes;
Webbike command nodes, making it possible to implement at least one pre-set operation after positioning on said “markup” language node or on said “frame”.

20. A system according to claim 19, characterised in that there is furthermore at least one of the following Webbike node types:
Webbike nodes of the type enabling the definition of an extraction sub-function;
Webbike nodes of the type enabling the display of the object or objects used in an extraction sub-function;
Webbike nodes of the type enabling the definition of a Webbike page;
Webbike nodes of the type able to be re-used with possibly a list of parameters;
Webbike nodes of the type enabling the declaration of the parameters of a page or of a re-usable node;
Webbike nodes of the type enabling another Webbike page to be called up without synchronisation on a “markup” language node;
Webbike nodes of the type enabling a re-usable node to be called up;
Webbike nodes of the type enabling the link to another Webbike page to be made;
Webbike nodes of the type enabling the definition of a dynamic URL for an HTML page;
Webbike nodes of the type enabling a value to be assigned to a parameter;
Webbike nodes of the type enabling a sequence of at least one Webbike node to be repeated;
Webbike nodes of the type enabling at least one command to be included in a normally unauthorised location of a sequence of at least one Webbike node;
Webbike nodes of the type enabling at least two methods of synchronisation to be defined depending on the content of a document;
Webbike nodes of the type enabling a sequence of at least one Webbike node to be interpreted conditionally.

21. A system according to claim 19, characterised in that said command type Webbike nodes belong to the group including:
Webbike nodes of the type enabling the definition of a block of at least one command associated with a node of the type enabling the definition of an extraction sub-function;
Webbike nodes of the type enabling the extraction of the textual content of a “markup” language node;
Webbike nodes of the type enabling the extraction of at least one attribute of the current “markup” language node;
Webbike nodes of the type enabling a constant value to be designated;
Webbike nodes of the type enabling functions to be provided for converting information extracted from a file expressed in a “markup” language.

22. A system according to claim 21, characterised in that said at least one command, of a block defined by a Webbike node, belongs to the following group:
object creation commands;
commands for modification of at least one object member.

23. A system according to any one of claims 17 to 22, characterised in that there are at least the two following Webbike page types:
static Webbike pages, analysed when launching said extraction sub-function;
dynamic Webbike pages, accessible from another Webbike page via a Webbike node of a particular type, called a Webbike link.

24. A system according to any one of claims 19 to 23, characterised in that there is at least one specific synchronisation Webbike node enabling a search for a pre-set “markup” language node, in order to position itself on said pre-set “markup” language node, and, additionally, a generic synchronisation Webbike node enabling a search for a non-pre-set “markup” language node which is not pre-set but specified as a parameter, in order to position itself on said non-pre-set “markup” language node.

25. A system according to any one of claims 19 to 24, characterised in that at least some of the synchronisation nodes take account of extraction conditions relating to attributes and/or to a textual content and/or to at least one son node of a found “markup” language node.

26. A system according to any one of claims 5 to 25, characterised in that said Webbike node implements a cookie management function.

27. A system according to claims 7 and 17, characterised in that at least one of said first and second specific languages is constructed using an XML language.

28. A system according to any one of claims 17 to 27, characterised in that said “markup” language belongs to the group including:
Extended Markup Languages (XML);
HyperText Markup Languages (HTML);
Standard Generalised Markup Languages (SGML) and derivatives;
Wireless Markup Languages (WML).

29. A process for implementing a system according to any one of claims 1 to 28, characterised in that it includes the following stages:
a terminal (3-10) issues a request (51) relating to a given application destined for said system (2);
to develop a response to said request, said response generation module (31) issues a request for at least one object to said at least one object creation module (30), so as to fill in the plurality of contexts of said application;
said at least one object creation module creates said at least one object and sends it back to said response generation module;
said response generation module generates a response in a generic presentation format, employing said browsing according to said browsing concept within said plurality of contexts;
said presentation module (32) receives from said response generation module said generic presentation format response and converts it into a response in a presentation format specific to the type of said terminal formulating said request;
said system sends said response in a presentation format specific to said terminal.

30. A process according to claim 29, characterised in that said process is iterative,
and in that the response to a given request depends on said browsing concept and on at least one request and/or previous response.
